(19) United States
(12) Patent Application Publication
(10) Pub. No.: US 2008/0030474 A1
(43) Pub. Date: Feb. 7, 2008

(54) Portable terminal

(75) Inventors: Akemi Toyokura, Tokyo (JP); Ayako Hosoi, Tokyo (JP); Natsuko Ouchi, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 11/809,277

(22) Filed: May 31, 2007

(30) Foreign Application Priority Data
Aug. 3, 2006 (JP) P2006-212569
Aug. 3, 2006 (JP) P2006-212570
Aug. 3, 2006 (JP) P2006-212571

(51) Int. Cl. G06F 3/02; H04M 1/00

(52) U.S. Cl. 345/169

(57) ABSTRACT

According to an aspect of the invention, there is provide a portable terminal including: a plurality of keys including a first key and a second key; a display section; and a display control unit configured to display a list of a first function menu in portrait orientation if the first key is depressed while a standby screen is displayed in the display section, and display a list of second function menu capable of being activated in landscape orientation if the second key is depressed while a standby screen is displayed in the display section.

### CROSS-REFERENCE TO RELATED APPLICATIONS

This application is based on and claims the benefit of priority from the prior Japanese Patent Applications No. 2006-212569, filed on Aug. 3, 2006, No. 2006-212570, filed on Aug. 3, 2006, and No. 2006-212571, filed on Aug. 3, 2006; the entire contents of which are incorporated herein by reference.

### TECHNICAL FIELD

The present invention relates to a portable terminal.

### BACKGROUND

### Description of related art

Recent progress and proliferation of a portable terminal have been remarkable. Particularly, in the field of a portable cellular phone, portable cellular phones equipped with various features have begun to come into circulation. Although a display of QVGA size has been common even in connection with a display provided in a portable cellular phone, JP-A-2006-186508 discloses that portable cellular phones equipped with displays of high performance and high image quality have started to become available (see, e.g., paragraph 0018 of JP-A-2006-186508).

### SUMMARY

According to an aspect of the invention, there is provide a portable terminal including: a plurality of keys including a first key and a second key; a display section; and a display control unit configured to display a list of a first function menu in portrait orientation if the first key is depressed while a standby screen is displayed in the display section, and display a list of second function menu capable of being activated in landscape orientation if the second key is depressed while a standby screen is displayed in the display section.

According to another aspect of the invention, there is provide a portable terminal including: a plurality of keys including a first key and a second key; a display section; and a display control unit configured to display a list of a first function menu in portrait orientation if the first key is depressed while a standby screen is displayed in the display section, and display a list of a second function menu capable of being activated in landscape orientation if the second key is depressed while a standby screen is displayed in the display section. If one of the first function menu is selected after display of the first function menu, the display control unit executes and displays a function corresponding to the one of the first function menu in portrait orientation. If one of the second function menu is selected after display of the second function menu, the display control unit executes and displays a function corresponding to the one of the second function menu in landscape orientation.

According to another aspect of the invention, there is provided a portable terminal including: a display section; a storage section configured to store an image data; a detection section configured to detect an electric current from the outside; and a control section configured to cause the display section to display the image data stored in the storage section if the detection section detects the electric current detected by the detection section.

According to another aspect of the invention, there is provided a portable terminal including: a display section configured to simultaneously display at least one function; an operation section including a plurality of keys; a control section configured to accept an operation corresponding to one of the at least one function if the operation is performed by a first key of the plurality of keys; and a switch control section capable of switching to a display relevant to the other of the at least one function if operation is performed by the second key of the plurality of keys.

### BRIEF DESCRIPTION OF THE DRAWINGS

In the accompanying drawings;

FIGS. 1A and 1B are exemplary external views of a portable cellular phone 1;

FIGS. 2A and 2B are exemplary external views of the portable cellular phone 1;

FIG. 3 is a view showing an example display of a display 5 of the portable cellular phone 1 and an example layout of a first key section 6a of a first housing section 2;

FIG. 4 is a view showing an example layout of a second key section 6b of a second housing section 4 of the portable cellular phone 1;

FIGS. 5A and 5B are views showing an example view of the portable cellular phone 1 during recharging while remaining connected to a recharging unit 20;

FIG. 6 is an exemplary block diagram briefly showing the configuration of the portable cellular phone 1;

FIG. 7 is an exemplary flowchart employed if each of the functions is activated from a standby condition of the portable cellular phone 1;

FIGS. 8A, 8B, 8C, and 8D are exemplary screen transition views acquired if each of the functions is activated from a standby condition of the portable cellular phone 1;

FIG. 9 is an exemplary flowchart adopted if the portable cellular phone 1 has received a mail while performing a function of some type;

FIGS. 10A, 10B, 10C, and 10D are exemplary screen transition views achieved in a case where the portable cellular phone 1 has received an incoming call if performing a function of some type;

FIGS. 11A, 11B, 11C, and 11D are exemplary screen transition views achieved in a case where, an incoming call has made an interrupt if the portable cellular phone 1 is performing a function of some type;

FIG. 12 is a view showing an example of the case where a main function screen and a sub-function screen are concurrently displayed in a display 5 of the portable cellular phone 1;

FIGS. 13A, 13B, 13C, 13D, 13E, and 13F are exemplary views showing setting of a subsidiary screen of the display 5 in the portable cellular phone 1;

FIG. 14 is an exemplary flowchart showing operation for activating a sub-function screen as a main function in the portable cellular phone 1 during the course of display of a main function screen and the sub-function screen;

FIGS. 15A, 15B, 15C, and 15D are exemplary screen transition views showing operation for activating a sub-function screen as a main function in the portable cellular phone 1 during the course of display of a main function screen and the sub-function screen;

FIG. 16 is an exemplary flowchart for describing a subsidiary screen display during execution of the music function in the portable cellular phone 1;

FIGS. 17A, 17B, 17C, and 17D are exemplary screen transition views for describing the subsidiary screen display during execution of the music function in the portable cellular phone 1;

FIGS. 18A, 18B, 18C, 18D, 18E, 18F, and 18G are exemplary views for describing a method for setting a photostand function in the portable cellular phone 1;

FIG. 19 is an exemplary flowchart for describing the photostand function of the portable cellular phone 1; and

FIGS. 20A, 20B, and 20C are exemplary screen transition views for describing the photostand function of the portable cellular phone 1.

### DESCRIPTION OF THE EMBODIMENTS

An embodiment of the present invention will be described by reference to the drawings.

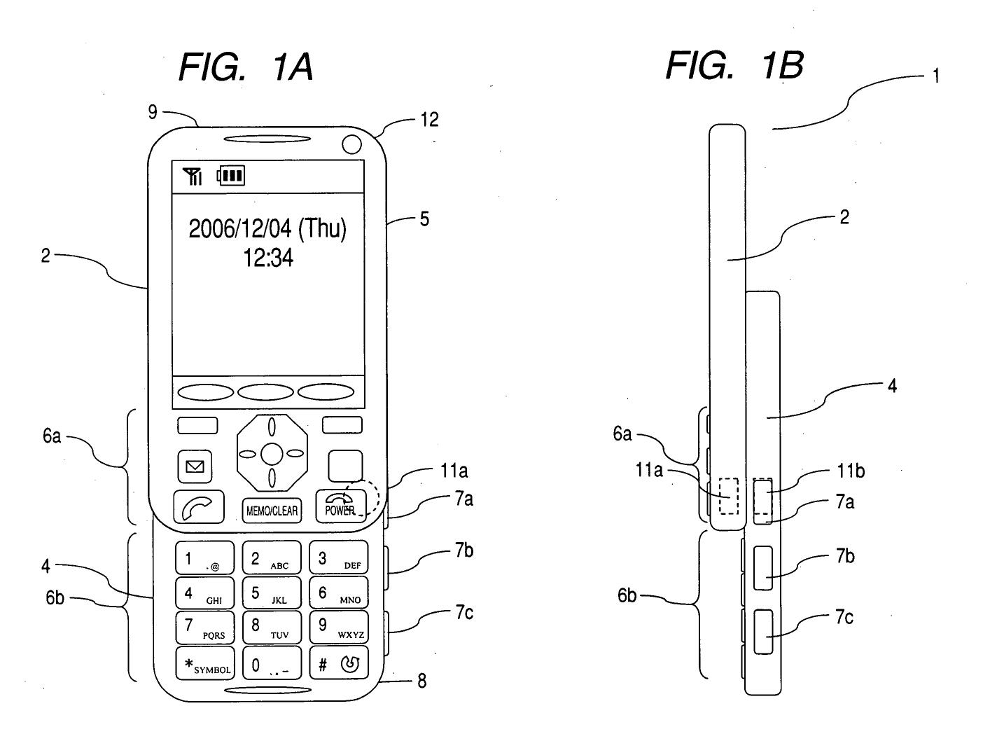

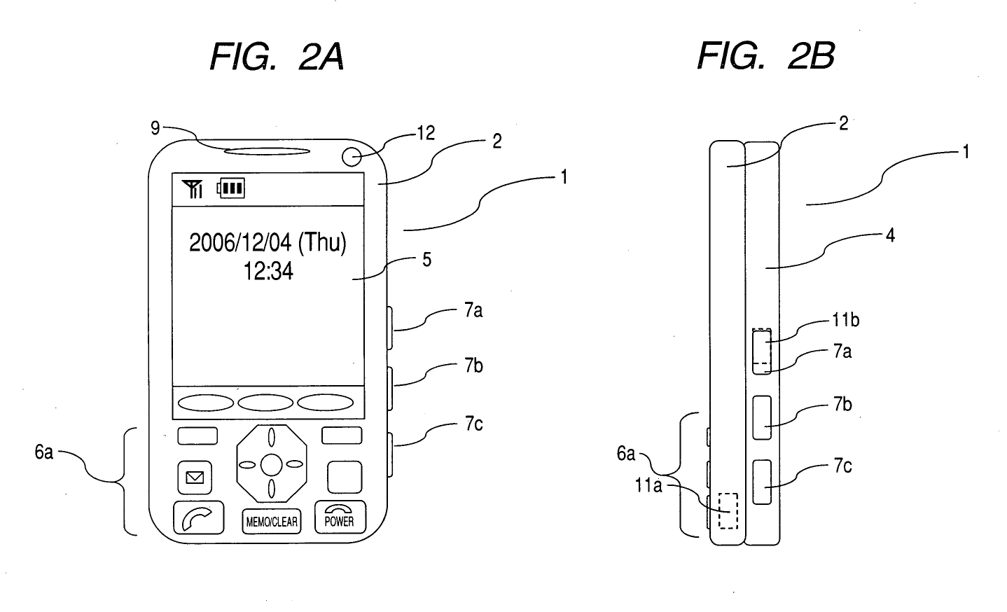

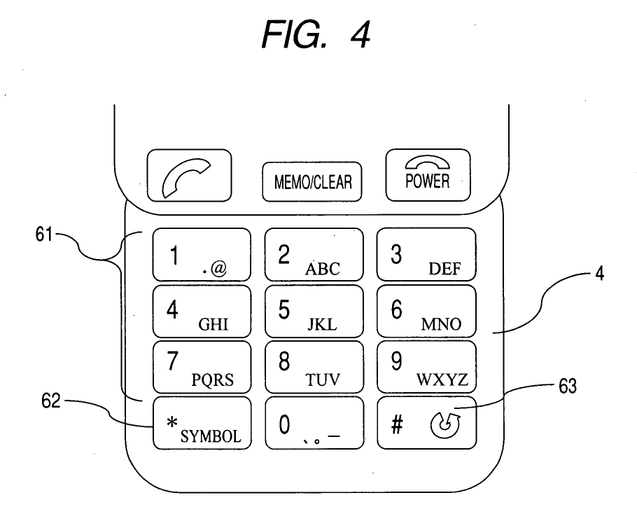

According to the embodiment, a portable cellular phone will be described hereunder by reference to the drawings. FIGS. 1A, 1B, 2A, and 2B are views showing the appearance of a portable cellular phone 1. FIG. 4 is a block diagram of the portable cellular phone 1.

First, the structure of the portable cellular phone 1 is described by reference to FIGS. 1A to 2B. FIG. 1A is a view of the portable cellular phone as viewed from the front, and FIG. 1B is a view of the same as viewed from the side.

FIG. 2A is a view of the portable cellular phone 1 as viewed from the front, and FIG. 2B is a view of the same as viewed from the side.

In the portable cellular phone 1, a first housing section 2 and a second housing section 4 are connected together so as to be slidable in a longitudinal direction thereof. The first housing section 2 has a display 5 such as an LCD; a first key section 6a consisting of multifunction keys, soft keys, or the like; a receiver 9 for producing a received voice; a magnetic sensor 11a for detecting the status of the portable cellular phone 1; and a camera 12. The display 5, the first key section 6a, and the camera 12 are provided on a single surface of the first housing section 2. The second housing section 4 has a second key section 6b used for inputting numerals and characters and for operation of the portable cellular phone 1, and so on; side keys 7a to 7c used for operating the portable cellular phone 1; a microphone (a mouthpiece) 8 for collecting sound; and a magnetic sensor 11b for detecting the status of the portable cellular phone 1. One or some of the side keys 7a to 7c may also be provided in the first housing section 2. As shown in FIGS. 1A and 1B, a state where the first housing section 2 and the second housing section 4 remain slid and where the second key section 6b is operable is hereinafter taken as the open state of the portable cellular phone 1. As shown in FIGS. 2A and 2B, a state where the first housing section 2 and the second housing section 4 essentially overlap each other and where the second key section 6b is inoperable is hereinafter taken as the closed state of the portable cellular phone 1.

As an example of the embodiment, the sliding-type portable cellular phone 1 is shown in FIGS. 1A and 1B. However, the embodiment is not limited to the housing of this shape but may also be a collapsible portable cellular phone or may be applicable to a portable cellular phone of another type. For instance, the open state can be applied to the open state of the collapsible portable cellular phone, and the closed state of the present embodiment can be applied to the closed state of the collapsible portable cellular phone.

If the magnetic sensors 11a and 11b of the portable cellular phone 1 are determined to be positioned close to each other, the portable cellular phone 1 is detected as being opened. Conversely, if the magnetic sensors are determined not to be positioned closely to each other, the portable cellular phone is detected as being closed.

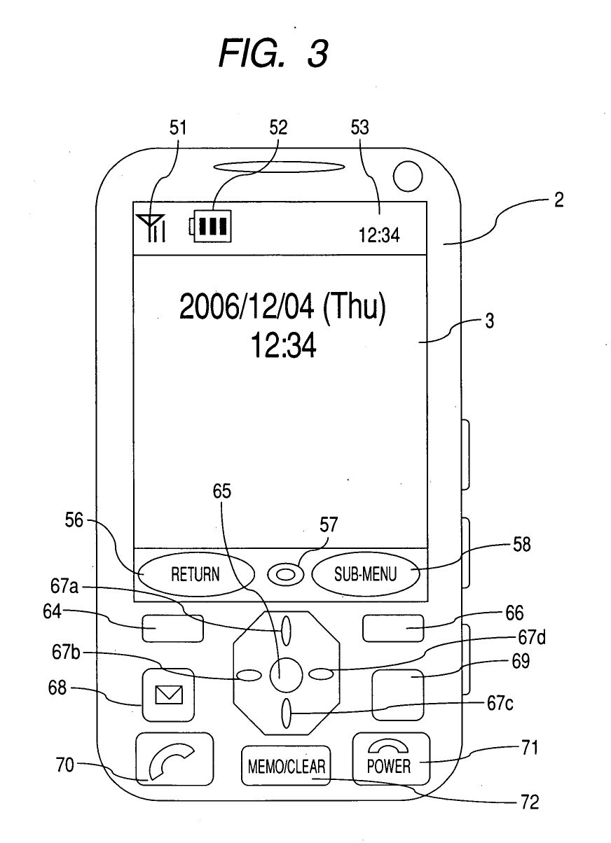

FIGS. 3 and 4 are views showing an example indication of the display 5 of the portable cellular phone 1 and an example layout of keys. FIG. 3 shows an example indication of the display 5 and an example layout of the first key section 6a of the upper housing section 2, and FIG. 4 shows an example layout of the second key section 6b of the second housing section 4.

As shown in FIG. 3, an antenna pictogram 51 showing the current sensitivity level of an antenna 117, a battery pictogram 52 showing the battery charge level of the portable cellular phone 1, and a time indicator 53 showing the current time are displayed on the top row (herein after called an “upper pictogram row”) in the display 5 of the portable cellular phone 1.

As shown in FIG. 3, the first housing section 2 has, as the first key section 6a, a left soft key 64, an ENTER key 65, a right soft key 66, cross-shaped keys 67a to 67d, a mail key 68, a shortcut key 69, a call key 70, a power key 71, and a clear key 72. The cross-shaped key 67a is usually used for scrolling a screen up; the cross-shaped key 67b is usually used for scrolling the screen left; the cross-shaped key 67c is usually used for scrolling the screen down; and the cross-shaped key 67d is usually used for scrolling the screen right. If the ENTER key 65 is depressed, various functions can be determined. Moreover, the mail key 68 can call the function for sending and receiving a mail. Even when any indication remains on the display 5 of the portable cellular phone 1, the shortcut key 69 is used at the time of calling of a previously-registered function, changing of the screen to a previously-registered screen, or the like.

The call key 70 is used chiefly for receiving a call or originating an ordinary call. The power key 71 is used primarily for activating or deactivating the power, terminating a call, and completing a function or an edit. Moreover, the clear key 72 is used principally for deleting a character during clearing of a function or an edit and during input of characters. If the clear key 72 is depressed with a standby screen being displayed, data recorded by a simplified automatic answering function can be played back.

In FIG. 3, the bottom row (hereinafter called a “lower pictogram row”) in the display 5 of the portable cellular phone 1 provides brief explanations of functions to be executed if any of the left soft key 64, the ENTER key 65, and the right soft key 66 are depressed in connection with the currently-displayed functions. An explanation of the left soft key 64 is displayed in a lower left pictogram 56; an explanation of the ENTER key 65 is displayed in a lower middle pictogram 57; and an explanation of the right soft key 66 is displayed in a lower right pictogram 58 (if a function displayed in the lower middle pictogram 57 can be entered, there may be a case where the pictogram is expressed by a double circle). For instance, if the left soft key 64 is depressed with a display such as that shown in FIG. 3 remaining, a function “return” is performed. If the ENTER key 65 is depressed, a currently-specified function can be selected even though it is not illustrated. If the right soft key 66 is depressed, a “sub-menu” appears.

As shown in FIG. 4, the second housing section 4 has, as the second key section 6b, at least numeral keys 61, a “*” key 62, and a “#” key 63. In addition to being assigned the numerals, the numeral keys 61 are assigned Japanese Kana characters, symbols, alphabetic characters, and the like. For instance, key “1” is assigned numeral “1”; and symbols “.” and “@.” Key “2” is assigned numeral “2”; Japanese Kana characters “ka, “ki,” “ku,” “ke,” and “ko”; and letters “A,” “B,” “C,” “a,” “b,” “c,” and the like. The “*” key 62 is assigned “*.” Moreover, in a character input state, the “*” key 62 can call a list of symbols and a list of pictograms. Further, the “#” key 63 is assigned “#.” In a character input state, the “#” key 63 enables toggling for character input performed by the numeral keys 61.

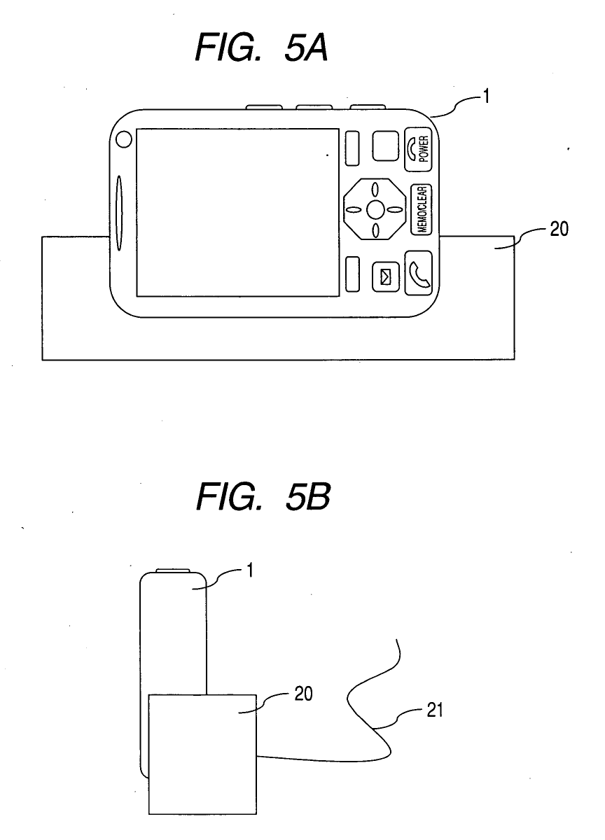

FIGS. 5A and 5B shows the appearance of the portable cellular phone 1 and that of a recharging unit 20 if they are connected together during recharging of the portable cellular phone 1. FIG. 5A is a view of the portable cellular phone as viewed from the front, and FIG. 5B is a view of the portable cellular phone and that of the recharging unit as viewed from the side. If recharging the portable cellular phone 1, the user can place the portable cellular phone in the recharging unit 20 while retaining the same in a laterally-oriented position. Upon detection of connection to the portable cellular phone 1, the recharging unit 20 receives an electric current from a power cord 21 and recharges the portable cellular phone 1. For instance, agiven electric current is feduntil alithium-ion battery (not shown) connected to the portable cellular phone 1 is recharged up to a certain voltage, and subsequently recharging operation is performed at a given voltage.

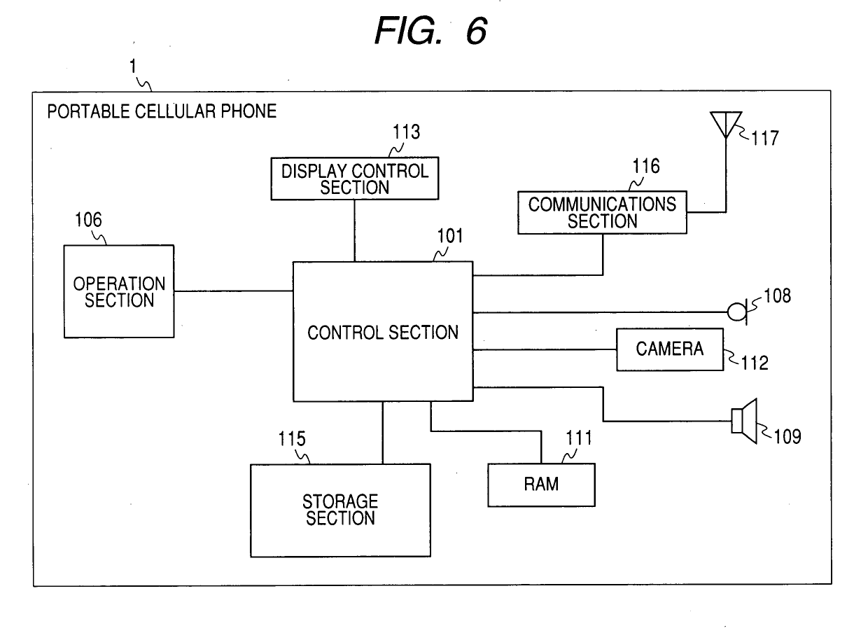

FIG. 6 is a block diagram briefly showing the configuration of the portable cellular phone 1. Provided in the portable cellular phone 1 are a control section 101 for controlling the entire portable cellular phone 1; a microphone control section 108; a speaker 109; a camera control section 112 for controlling the camera 12; a nonvolatile storage section 115 consisting of ROM or NAND memory; volatile RAM 111 for effecting temporary storage; a display control section 113 for controlling displaying operation of the display 5; an operation control section 106 which perceives depression of any one of the first key section 6a, the second key section 6b, and the side keys 7a through 7c and which transmits to the control section 101 information corresponding to depression of the key; and a communications section 116 which effects wireless communication by use of the antenna 117. The control section 101 controls the entirety of the portable cellular phone 1.

Programs to be executed by the control section 101 and information data of various types are stored in the storage section 115.

The display control section 113 controls displaying operation of the display 5, and subjects display data output and ordered by the control section 101 to display control.

The communications section 116 has the function of transmitting the information ordered by the control section 101 by wireless communication and receiving the information transmitted by a server through wireless communication. For instance, downloading of music, or the like, used for a music playback function from the server is also performed by the communications section 116 and the antenna 117.

The camera control section 112 is activated by the control section 101, and the image input by the camera 12 is displayed on the display 5 by the display control section 113.

The operation control section 106 perceives depression of the first key section 6a, the second key section 6b, and the side keys 7a to 7c. A key input section 106a can perceive depression of any of a plurality of keys including the numeral keys, the character keys, and function keys which are used for determining or aborting edition of an E-mail. In response to an input generated as a result of input operation of the first key section 6a, the second key section 6b, or the side keys 7a to 7c having been performed by the user, the key input section reports to the control section 101 an identification signal for identifying a key. The control section 101 commences operation corresponding to the identification signal.

[Startup of Each of Functions]

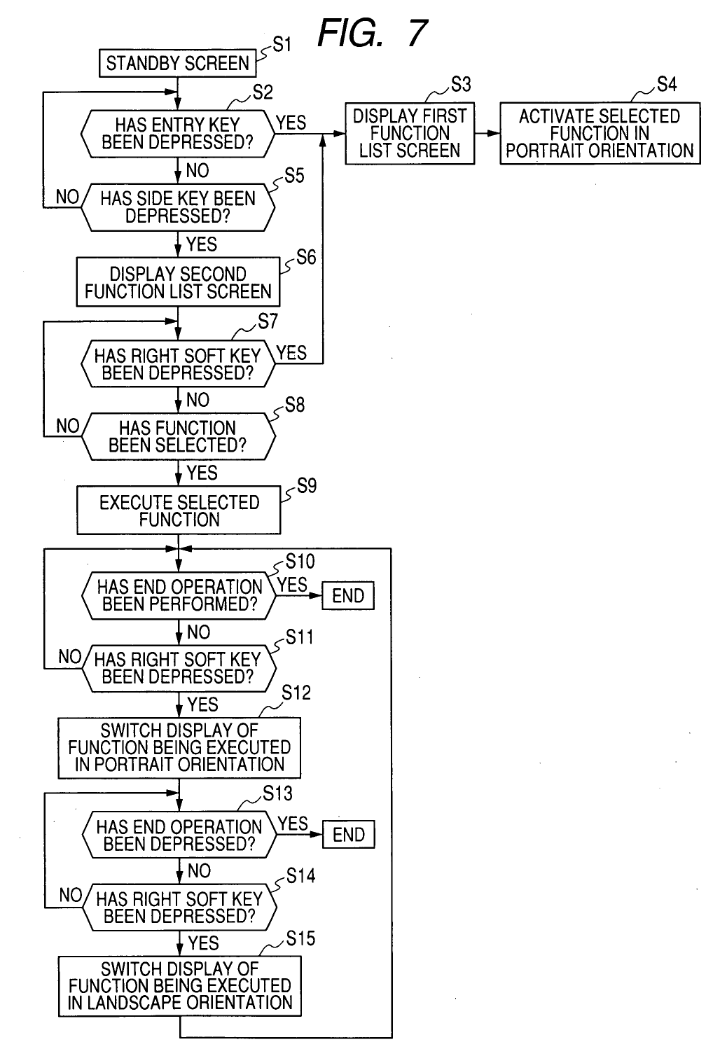

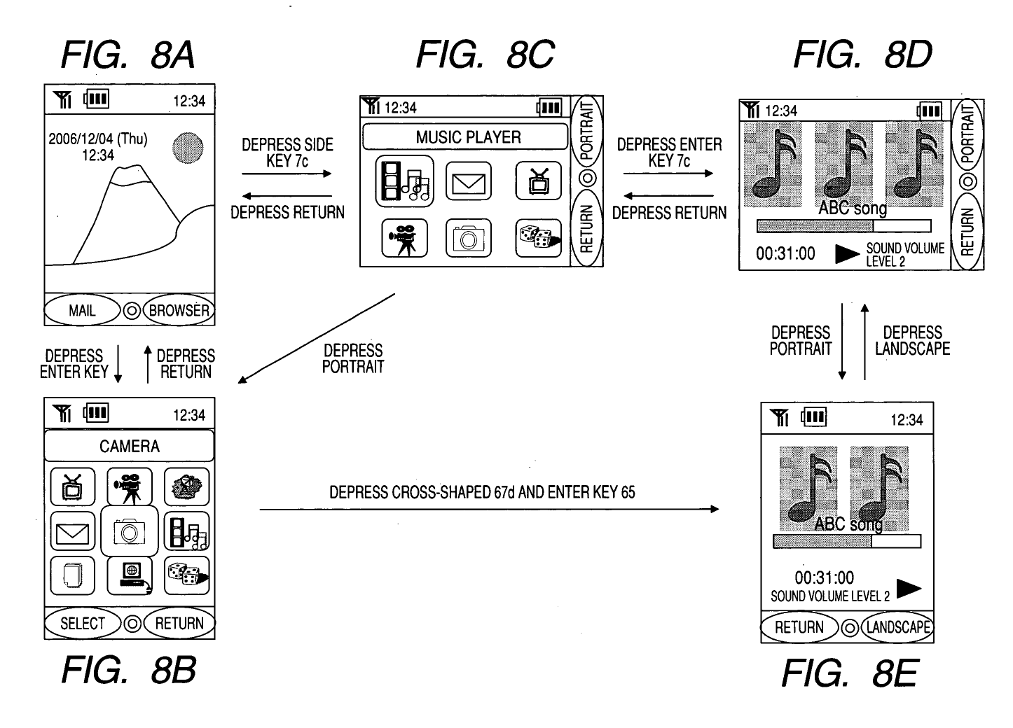

Flows of processing performed at the time of start-up of eachof functions in the standbystate of theportable cellular phone 1 of the embodiment of the present invention will now be described by reference to FIGS. 7 and 8A-8E. In the present embodiment, an expression “displayed in a lateral orientation” signifies that characters or drawings are on the display 5 while the longitudinal direction thereof is oriented in a horizontal direction as indicatedby, e.g., FIGS. 8C and 8D. An expression “displayed in a longitudinal direction” signifies that characters or drawings are displayed on the display 5 while the longitudinal direction thereof is oriented in a vertical direction as shown in, e.g., FIGS. 8A, 8B, and 8E.

FIG. 7 is a flowchart employed if each of the functions is started from the standby condition. Descriptions are provided by use of, as required, a screen transition views shown in FIGS. 8A-8E in conjunction with the flowchart shown in FIG. 7.

First, the control section 101 determines (step S2) whether or not the ENTER key 65 has been depressed with a standby screen, such as that shown in FIG. 8A, being displayed (step S1). If determining that the ENTER key 65 has been depressed (Yes is selected in step S2), the control section 101 displays a first function list screen (step S3). For instance, the first function list screen is a screen such as that shown in FIG. 8B, and an initial state is a state where a predetermined function is selected (for example, if nine functions are displayed, a camera function located in the center of the functions is tentatively selected). If the ENTER key 65 is depressed with the desired function being tentatively selected by the cross-shaped keys 67a to 67d, the function tentatively selected in portrait orientation is executed (step S4). Here, for example, implementing a function in portrait orientation signifies a state such as that shown in FIG. 8E.

Meanwhile, if the control section 101 has failed to detect depression of the ENTER key 65 in step S2 (No is selected in step S2), a determination is made, through detection, as to whether or not the side key 7c has been depressed (step S5). If depression of the side key 7c is not detected (No is selected in step S5), processing pertaining to step S2 is reperformed. If having detected depression of the side key 7c, the control section 101 displays a second function list screen (step S6) The second function list screen shows, for instance, a list of functions which can be activated in landscape orientation, such as that shown in FIG. 8C.

The first function list screen shows a list of functions which can be activated in either portrait or landscape orientation, and the second function list screen shows a list of functions which can be activated in landscape orientation. Although functions which can be activated solely in portrait orientation are not displayed, display of functions is not limited to this manner. Control may also be carried out such that the functions that can be activated solely in portrait orientation are also displayed in a selection-disabled manner along with the functions that can be activated solely in landscape orientation; or such that the mode of display of the functions that can be activated in only portrait orientation and the mode of display of the functions that can be activated in only landscape orientation may also be changed. The second function list screen may also display a list of functions which can also be activated in landscape orientation among the functions displayed by the first function list screen (nine functions in the case of the example shown in FIG. 8B).

As shown in FIG. 8C, if the second function list screen is displayed, a desired function among the displayed list of functions is tentatively selected (for instance, if six functions are displayed, a music player function located at an upper left position is tentatively selected).

If a screen is displayed in landscape orientation as shown in FIG. 8C in steps subsequent to FIG. 8C, key assignments are changed. If the screen is displayed in landscape orientation, upward movement relative to a landscape display standard is assigned to the cross-shaped key 67d; downward movement relative to the landscape display standard is assigned to the cross-shaped key 67b; leftward movement relative to the landscape display standard is assigned to the cross-shaped key 67a; and rightward movement relative to the landscape display standard is assigned to the cross-shaped key 67c.

After having displayed the second function list screen in step S6, the control section 101 determines whether or not the right soft key 66 has been depressed (step S7). If the right soft key 66 is depressed, the second function list screen is switched to the first function list screen (Yes is selected in step S7, and processing proceeds to step S3).

If the right soft key 66 is determined not to have been depressed, a determination is made as to whether or not a function has been selected from the display function list by the cross-shaped key 67 or the ENTER key 65 (step S8). If the function is determined not to have been selected, processing is reperformed from step S7 and subsequent steps (No is selected in step S8). If the function is determined to have been selected (Yes is selected in step S8), the control section 101 activates the function selected as shown in FIG. 8D (the music player function in the embodiment shown in FIGS. 8A-8E) in landscape orientation and executes the thus-activated function (step S9).

After having started execution of the function in landscape orientation as shown in FIG. 8D, the control section 101 determines whether or not end operation has been performed (step S10). If end operation is performed, processing is completed (END). If the end operation is determined to not have been performed, processing proceeds to step S11.

Next, in step S11 the control section 101 determines whether or not the right soft key 66 has been depressed (step S11). If determining that the right soft key 66 has not been depressed, the control section 101 re-executes processing pertaining to step S10. If the right soft key 66 is determined to have been depressed, the display of the function being executed is switched from the portrait orientation to the landscape orientation as shown in, e.g., FIG. 8E, and execution of an analogous function is continued (step S12).

During the course of execution of a function in a portrait orientation as shown in FIG. 8E, the control section 101 determines whether or not end operation has been performed (step S13), and processing is completed if the end operation is performed (END). If the end operation is determined to not have been performed, processing proceeds to step S14.

Next, in step S14 the control section 101 determines whether or not the right soft key 66 has been depressed (step S14). If the right soft key 66 is determined to not have been depressed, the control section 101 reperforms processing pertaining to step S13. If the right soft key 66 is determined to have been depressed, the display of the function being executed is switched from landscape orientation to portrait orientation as shown in, e.g., FIG. 8D, and execution of a function analogous to the function being executed is continued (step S15). Subsequently, processing returns to step S10.

As mentioned above, each of the functions can be activated in a switchable manner in portrait orientation or landscape orientation in response to a key to be depressed, and hence the user does not need to change the manner of holding the phone in accordance with the orientation of a display, and the portable cellular phone becomes easier to use.

[Status of the Housing and Synchronous Actuation of the Functions]

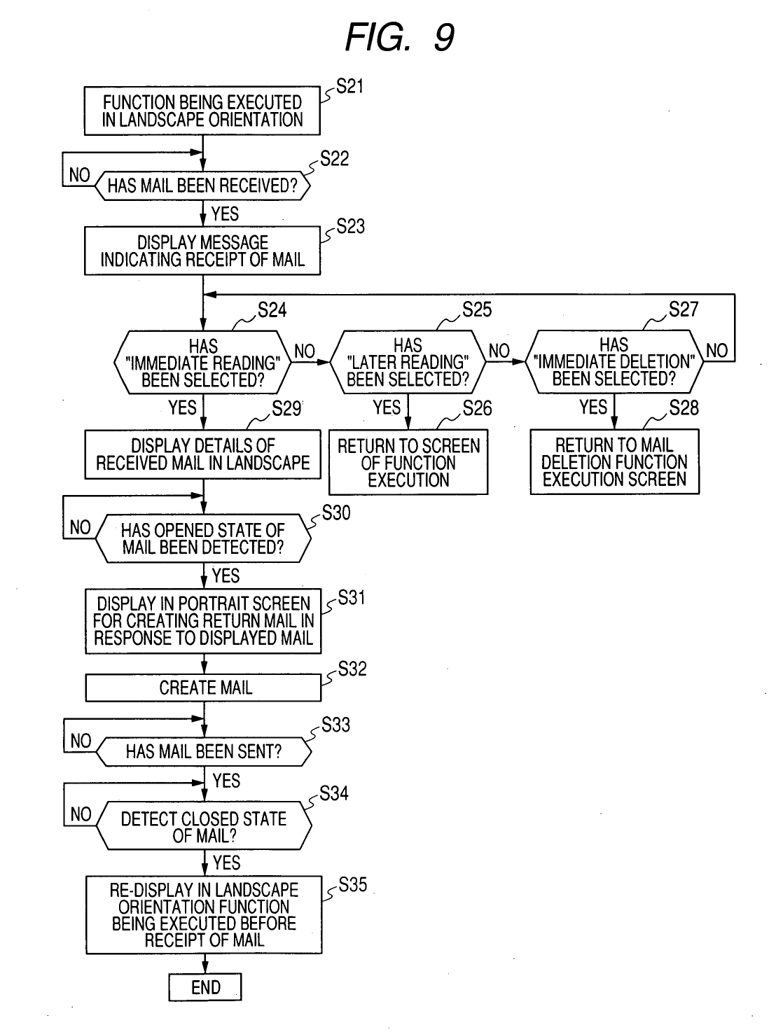

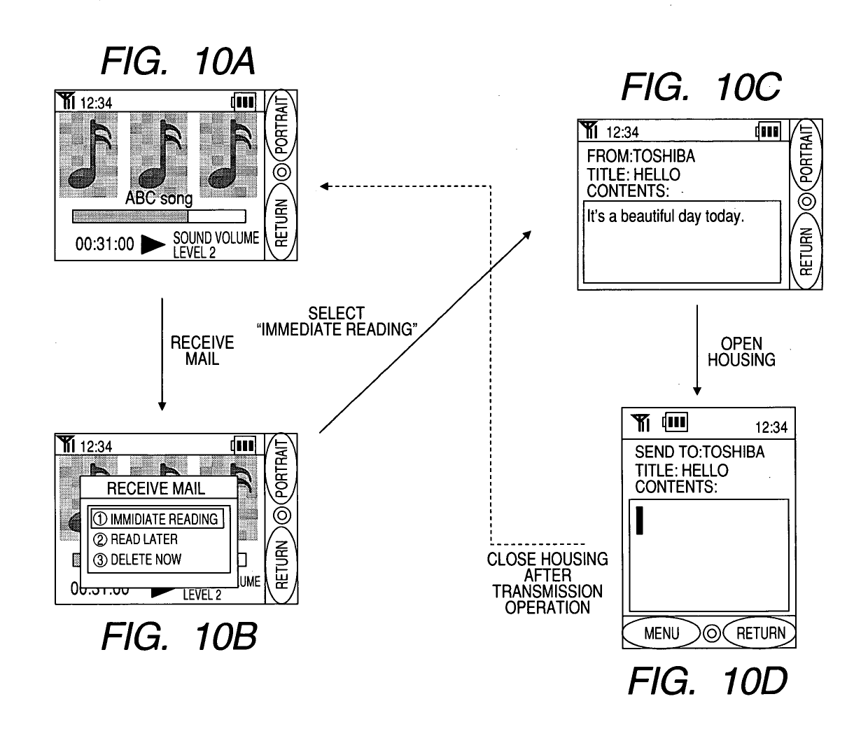

The flow of operation performed if an interrupt; for example, receipt of a mail or an incoming call, has arisen during the course of execution of a predetermined function of the portable cellular phone 1 in the embodiment of the present invention will now be described by reference to FIGS. 9 and 10A-10D.

First, FIG. 9 is a flowchart showing operation performed if a mail is received while a function of some type is activated in landscape orientation and a music player screen is being displayed. An explanation is provided by use of, as required, a screen transition views of FIGS. 10A-10E in conjunction with the flowchart shown in FIG. 9.

Initially, if the portable cellular phone 1 holds a music function activated (the function is not limited to the music function) and is displaying a music player screen such as that shown in FIG. 10A (step S21 and analogous to the screen of FIG. 8D), the control section 101 determines whether or not the communications section 116 has received a mail (step S22). If the mail is not received, processing pertaining to step S22 is reperformed. If determining that the mail has been received (Yes is selected in step S22), the control section 101 stores the received mail in the RAM 111 or the storage section 115, and controls the display control section 113 so as to display a mail receipt screen on the display 5 in landscape orientation (step S23). An example where a mail is displayed on the display 5 in step S23 corresponds to a screen such as that shown in FIG. 10B. Descriptions are provided here under on the assumption that the screen in FIG. 10B has been displayed.

Next, for instance, three options; namely, “Immediate reading of a received mail,” “Reading of a received mail later,” or “Immediate deletion of a received mail,” are displayed on the screen shown in FIG. 10B. While the options are displayed, the control section 101 determines, through use of the cross-shaped key 67 or the ENTER key 65, whether “Immediate reading of a received mail” has been selected (step S24), “Reading of a received mail later” has been selected (step S25), or “Immediate deletion of a received mail” has been selected (step S27). If none of the options have been selected, processing pertaining to steps S24, S25, and S27 is iterated.

If determining, in step S25, that “Reading of a received mail later” has been selected, the control section 101 causes the mail receipt screen to disappear, and the screen returns to a screen of function execution such as that shown in FIG. 10A (step S26).

If determining, in step S27, that “Immediate deletion of a received mail” has been selected, the control section 101 erases the received mail from the RAM 111 or the storage section 115 (step S28). If information relevant to the received mail is stored in an unillustrated server, access may also be made to the server by the communications section 116, thereby transmitting information to the effect that information relevant to that mail stored in the server is erased.

Next, if determining, in step S24, that “Immediate reading of a received mail” has been selected (Yes is selected in step S24), the control section 101 controls the display control section 113 so as to display on the display 5 details of the received mail in landscape orientation (step S29). For example, a screen displayed in step S29 is as shown in FIG. 10C, and a sender (TOSHIBA), a title, and a body are displayed. If the body of the mail is displayed in step S29, details of the mail may also be displayed, at the time of display of details of the mail as shown in FIG. 10C, concurrently with the music player screen having been displayed immediately before.

The control section 101 next determines whether or not the housings of the portable cellular phone 1 have changed from a closed state (first state) to an open state (second state) after the details of the mail have been displayed in step S29 (step S30). This determination is rendered from, e.g., a relationship between the magnetic sensors 11a and 11b, as well. If the phone has already been opened if the mail is displayed, the determination pertaining to step S30 is rendered as No. Processing pertaining to step S30 is iterated until the status of the portable cellular phone 1 is determined to have changed from the closed state to the opened state (No is selected in step S30).

If the status of the portable cellular phone 1 is determined to have changed from the closed state to the opened state (Yes is selected in step S30), the control section 101 displays in portrait orientation a screen for composing a return mail addressed to the destination of the displayed mail (step S31) The return mail composition screen is as shown in, e.g., FIG. 10D. Automatic setting of a destination and a title and displaying of a cursor at the beginning of the main body of a mail are desirable, but the embodiment is not limited to such a setting.

After the mail composition screen has been displayed in portrait orientation in step S31, a return mail is composed of the information input by the first key section 6a or the second key section 6b (step S32). Subsequently, the control section 101 determines that operation for transmitting a mail has been performed (step S33). If operation for transmitting a mail has been performed, the control section 101 causes the communications section 116 to transmit the mail.

After transmission of the mail, a determination is made as to whether or not the housings of the portable cellular phone 1 are closed (step S34). If the housings of the portable cellular phone 1 are determined to have been closed, the music player screen of the function executed before receipt of the mail (the music function in this case) is displayed in landscape orientation (step S35).

In relation to the flowchart shown in FIG. 9, the above example shows a case where the music function is being executed. However, even if a mail is received in, for instance, step S22, continuance of a sound output generated by the music function in step S22 and subsequent steps is desirable. However, the embodiment is not limited to such an example.

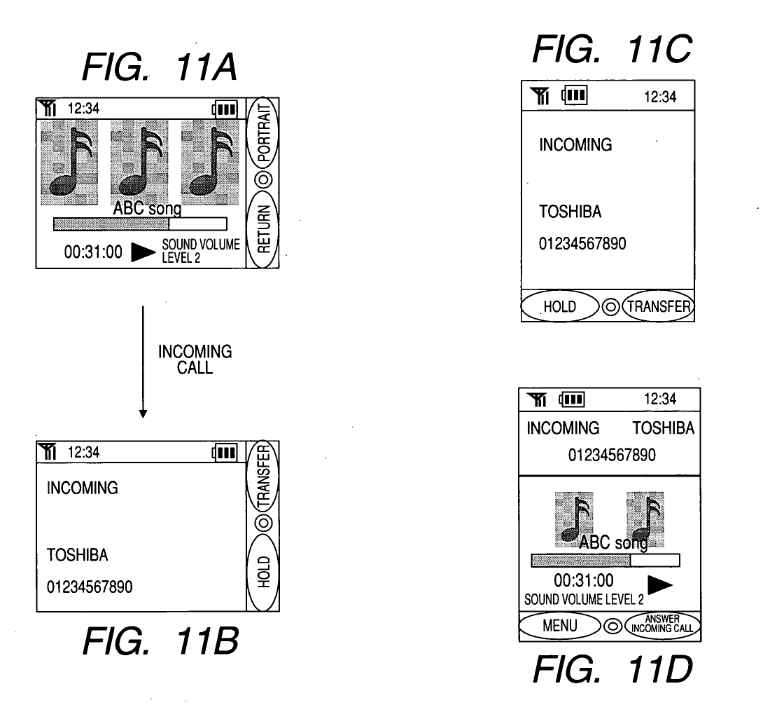

FIG. 9 shows the flowchart adopted if a mail is received during the course of execution of a function of some type. However, as will be described later, the flowchart is also applicable to a case where an incoming call is received during the course of execution of a function of some type. FIGS. 11A-11D are views showing an example where an incoming call is received during execution of a function of some type. In FIG. 11A, for instance, a music function is executed as in the case of FIG. 10A. If an incoming call is detected while the music player screen is displayed in landscape orientation, an incoming call screen may also be displayed in landscape orientation as shown in FIG. 11B, or the incoming call screen may also be displayed in portrait orientation as shown in FIG. 10C. As shown in FIG. 11D, two screens; i.e., the music player screen and the incoming call screen, may also be displayed. In the case of display of two screens shown in FIG. 11D, a response can be made to the incoming call if the right soft key 66 is depressed.

As mentioned above, the display is changed or the function is executed in accordance with the status of the housings. Hence, the user can quickly address browsing of a mail and a response at the time of receipt of a return mail or an incoming call, and hence further ease of use is attained.

[Subsidiary Screen Displays]

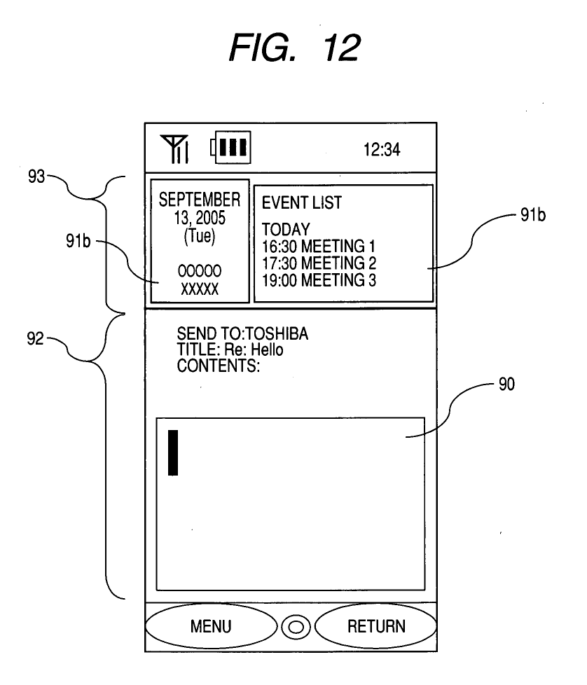

Subsidiary screen displays of the portable cellular phone 1 of the embodiment of the present invention will now be described by reference to FIGS. 12 through 15D. As shown in FIG. 12, the subsidiary screen displays correspond to sub-function screens employed if screens 91a and 91b of sub-functions are displayed, in addition to corresponding to a display 92 of a single main function currently being activated. A screen of a main function is displayed in a main function display area 92, and a screen of a sub-function is displayed in a sub-function display area 93. In principle, if the first key section 6a and the second key section 6b are depressed, operation responsive to depression of the keys is performed in connection with a single main function (and a display thereof). Exceptionally (if an incoming call is received or a mail is received), there may also arise a case where operation responsive to a sub-function (and a display thereof) can be accepted in connection with a certain key (e.g., the right soft key 66 of FIG. 11D to be described later).

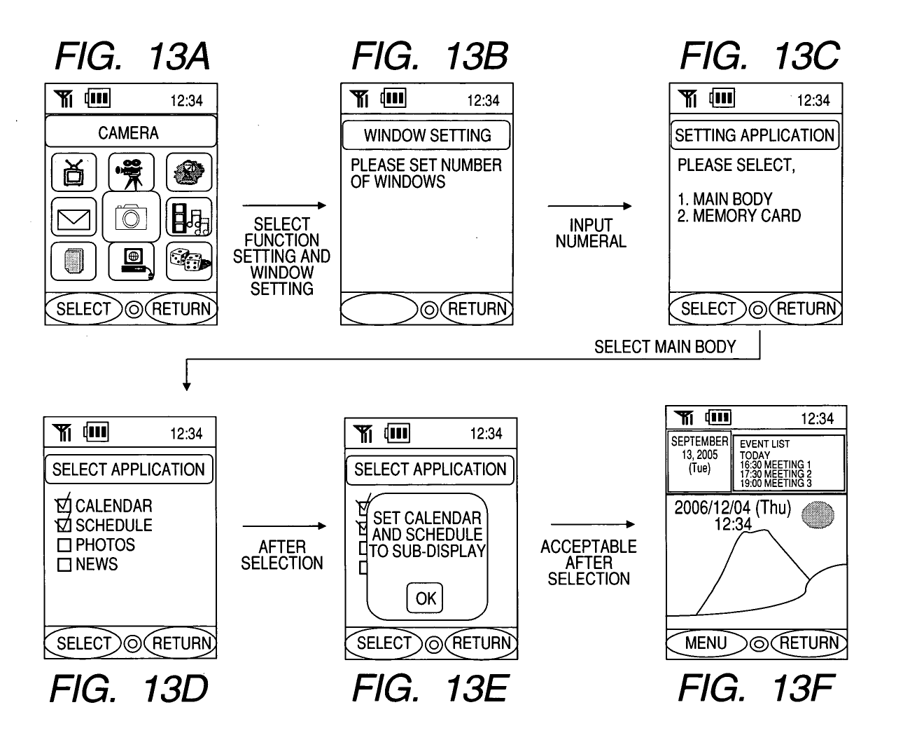

FIGS. 13A-13F are views for describing settings of the subsidiary screens of the display 5 of the portable cellular phone 1. First, if the ENTER key 65 is depressed on the standby screen, the first function list screen (details thereof have been described by reference to FIGS. 8A-8E, and the like, and hence are omitted here for brevity) is displayed as shown in FIG. 13A. Subsequently, if predetermined operation, such as a “function setting,” “window setting,” or the like, is performed on the first function list screen, there appears a screen, by which there is input the number of subsidiary screens to be displayed in the sub-function display area 93 (FIG. 13B). The sub-function display area 93 is displayed in a split form in accordance with the input number.

If the number is input, functions to be displayed as subsidiary screens can be selected by the cross-shaped key 67 or the ENTER key 65 as shown in FIGS. 13C, 13D, and 13E. Although the functions to be selected can be selected in FIG. 13D, functions cannot be selected in excess of the number input in FIG. 13B.

If the number of functions (applications) set so as to be displayed in FIG. 13D has been selected, a check screen is displayed as shown in FIG. 13E. If “OK” is selected, a standby screen appears in the main function display area 92 as shown in FIG. 13F. Displays of the selected functions (a calendar function and a schedule function are taken as examples in the present embodiment) are provided side by side in the sub-function display area 93.

Taking a single function as a single piece and displaying functions side by side within the sub-function display area 93 have been described. However, the embodiment is not limited to this case. If contents including a calendar function and a schedule function are displayed, a single function may also be taken as a single piece. Moreover, in relation to the display of a subsidiary screen, there may also be provided settings for displaying a subsidiary screen in response to all displays to be provided on the display 5 of the portable cellular phone 1 or settings for making effective a subsidiary screen if a screen of one of functions or a screen of one of predetermined functions is displayed.

After settings for displaying the subsidiary screen have been made, there is no necessity for immediately displaying a subsidiary screen. There may also be performed control operation such that, if a previously-determined key has been depressed, a subsidiary screen is displayed.

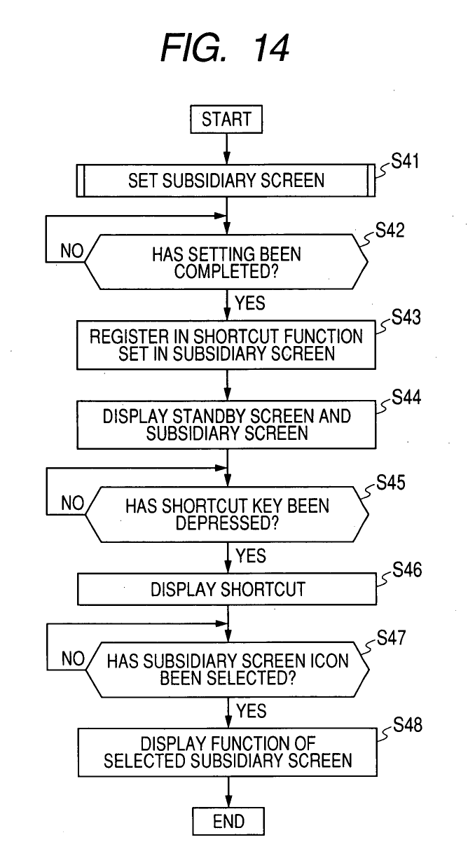

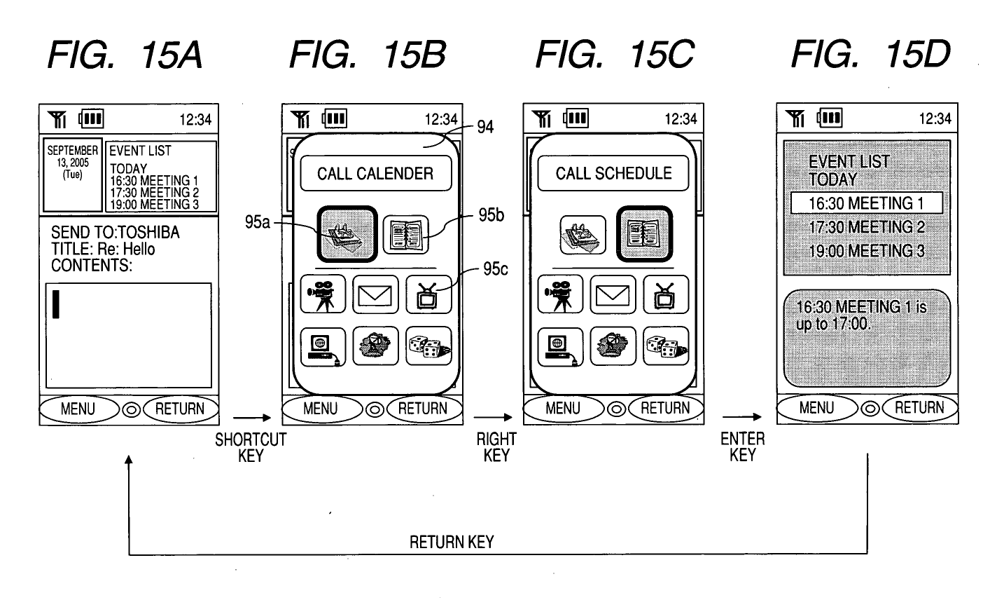

Operation for rendering the screen of sub-functions active as a main function during the course of display of screens of the main function and during the course of display of screens of sub-functions will be described by reference to FIGS. 14 and 15A-15D.

FIG. 14 is a flowchart showing operation for activating a sub-function screen as a main function in the middle of display of the main function screen and the sub-function screen. Descriptions are provided by use of, as required, a screen transition views of FIGS. 15A-15D in conjunction with the flowchart shown in FIG. 14.

First, as described by reference to FIGS. 13A-13F, there is effected a setting for displaying a subsidiary screen (step S41). If the setting for displaying a subsidiary screen has been completed (Yes is selected in step S42), the function displayed and set as a subsidiary screen is stored in the RAM 111 or the storage section 115. In order to enable invoking of the function as a shortcut, the function displayed and set as a subsidiary screen is registered in connection with the shortcut (step S43).

Next, if the screen has returned to the standby screen after completion of the setting, the standby screen is displayed, in the manner mentioned previously, in the main function display area 92 as shown in FIG. 13F, and the set subsidiary screen is displayed in the sub-function display area 93 (step S44). If each of the functions is activated after display processing pertaining to step S44, the function displayed in the main function display area 92 changes from one function to another. For instance, if a mail function is activated in the screen shown in FIG. 13F, a mail screen is displayed in the main function display area 92 as shown in FIG. 15A. As in the case of FIG. 13F, a calendar function and a schedule function are displayed in the sub-function display area 93.

In a state where an arbitrary screen is displayed as shown in, e.g., FIG. 15A, the control section 101 determines whether or not the shortcut key 69 has been depressed (step S45). If the shortcut key 69 is determined not to have been depressed, processing pertaining to step S45 is continued. If the short cut key 69 is determined to have been depressed, the control section 101 invokes to display a shortcut screen 94 as shown in, e.g., FIG. 15B (step S46). In step S43, subsidiary screen icons 95a and 95b and a shortcut 95c of the function registered in the subsidiary information are displayed on the shortcut screen 94. In an example shown in FIG. 15B, the subsidiary screen icon 95a shows an icon which invokes the calendar function. The subsidiary screen icon 95b shows an icon used for invoking the schedule function. The shortcut 95c is one of the functions previously set by the user.

Focus is placed on the subsidiary screen icon 95a as an initial screen invoking the shortcut screen 94. If the cross-shaped key 67d is depressed, focus is placed on the subsidiary screen icon 95b as shown in FIG. 15C.

In step S47, the control section 101 determines whether or not the subsidiary screen icon has been selected. If the subsidiary screen icon has not been selected, processing pertaining to step S47 is reperformed. If the subsidiary screen icon is selected, a function corresponding to the selected subsidiary screen is executed, and the function is displayed (step S48). Display of the function in step S48 corresponds to a display such as that shown in, e.g., FIG. 15D. If the function for calling a schedule is selected, the schedule function is displayed in an area which is a merge of the main function display area 92 and the sub-function display area 93. The display of FIG. 15D may also be an enlarged display of the subsidiary screen or a display of detailed information along with a display of the subsidiary screen (in the embodiment shown in FIG. 15D, detailed information is displayed concurrently with the subsidiary screen display).

If the right soft key 66 is depressed with the screen of FIG. 15D displayed, the control section 101 performs control operation such that the screen returns to a screen which displays both the main function and the sub-function, as shown in FIG. 15A.

As mentioned above, since both the main function and the sub-function can be displayed, a wasteful display area is not created, and much convenience is afforded to the user.

[Display of the Subsidiary Screen Acquired During Execution of Music Function]

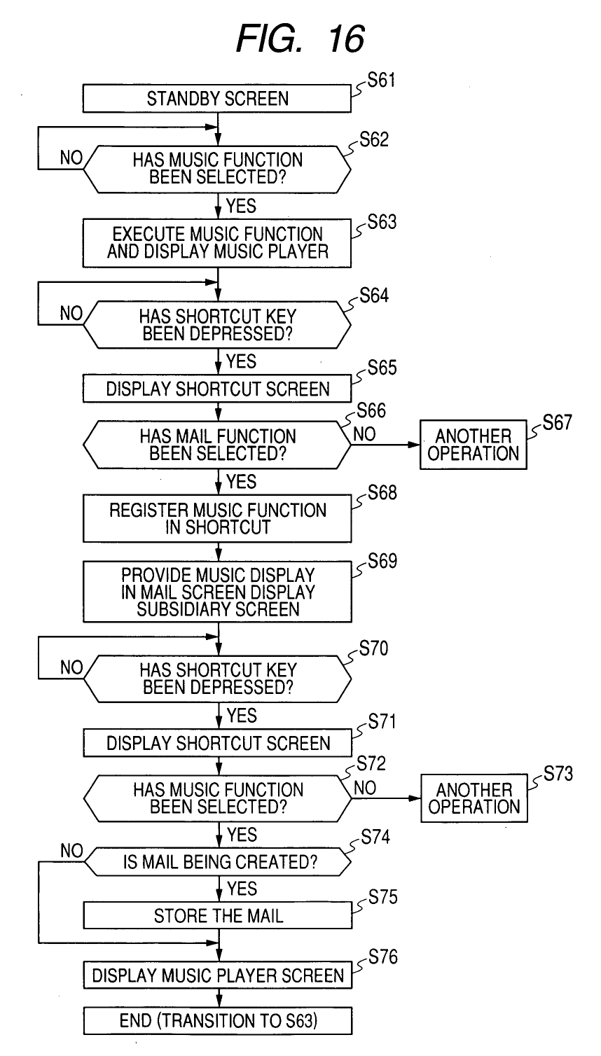

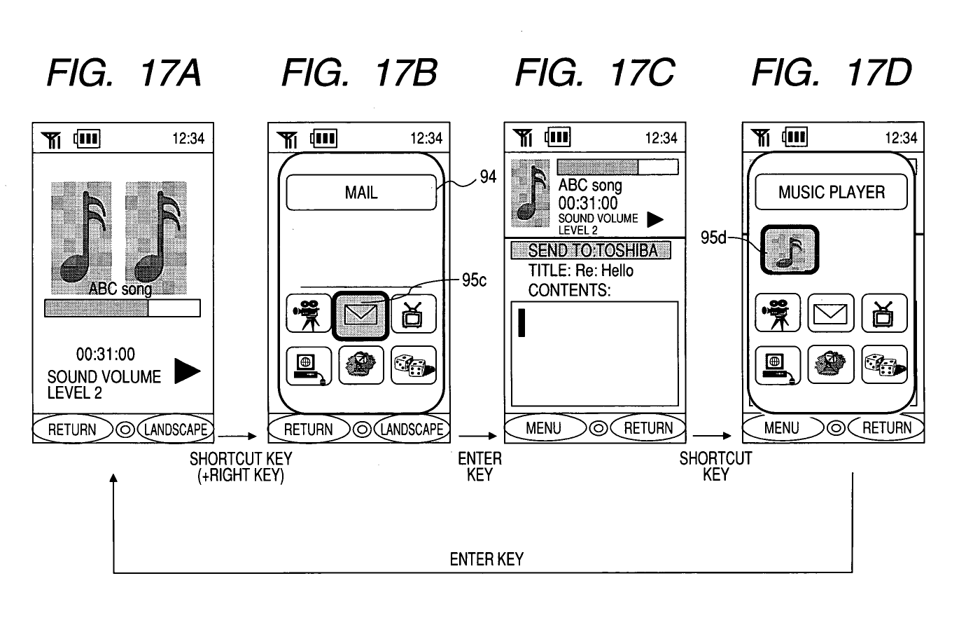

The display of a subsidiary screen performed during execution of the music function of the portable cellular phone 1 of the embodiment of the present invention will now be described by reference to FIGS. 16 and 17.

First, FIG. 16 is a flowchart for describing a display of a subsidiary screen acquired during execution of the music function. Descriptions are provided by use of, as required, screen transition views of FIGS. 17A-17D in conjunction with the flowchart shown in FIG. 16.

In a state where the standby screen is displayed (step S61), the control section 101 determines whether or not the music function has been activated (step S62). If the music function is activated, desired music is played back, and the music player is displayed (step S63). Since processing up to step S63 has been described in detail by reference to FIGS. 7 and 8A-8E, repeated detailed descriptions are omitted.

Next, in a state where the music function is being executed and the music player is being displayed (e.g., a display of FIG. 17A), a determination is made as to whether or not the shortcut key 69 has been depressed (step S64). If the shortcut key 69 has not been depressed, processing pertaining to step S64 is reperformed. Moreover, if the control section 101 determines that the shortcut key 69 has been depressed, the shortcut screen 94 is displayed as shown in FIG. 17B (step S65). In FIG. 17B, in contrast with the case shown in FIGS. 15A-15D, provided that a subsidiary screen is not set, the subsidiary screen icon 95a, or the like, is not registered at all. Hence, no icons are displayed (if the subsidiary screen is registered, the subsidiary screen icon is displayed).

The control section 101 determines whether or not the shortcut 95c has been selected (e.g., the mail function, but another function may also be acceptable) (step S66). If the mail function is not selected, another operation is performed (step S67). If the control section 101 determines that the mail function has been selected, the music function is registered as a shortcut into the storage section 115 or the RAM 111 (step S68). A display of the selected mail function is provided in the main function display area 92, and a display of the music function executed before activation of the shortcut is displayed in the sub-function display area 93 (step S69). An example screen pertaining to step S69 is shown in FIG. 17C.

As shown in FIG. 17C, after the mail function and the music function have been displayed, a determination is made as to whether or not the shortcut key 69 has been depressed (step S70). If having determined that the shortcut key 69 has been depressed, the control section 101 causes the display 5 to display the shortcut screen 94 as shown in FIG. 17D (step S71). The subsidiary screen icon 95d of the music player function appearing in the sub-function display area 92 is displayed as an initial screen on the shortcut screen 94, and focus is placed on the subsidiary screen icon 95d.

In step S72, a determination is made as to whether or not the subsidiary screen icon 95d of the music function has been selected from the subsidiary screen icon 95d appearing in the shortcut screen 94 and the shortcut icons (step S72) If determining that the subsidiary screen icon 95d of the music function has not been selected, the control section 101 performs another operation (step S73). If determining that the subsidiary screen icon 95d of the music function has been selected, the control section 101 determines whether or not there is a mail which is being created by the mail function displayed thus far (step S74). If a mail is being created, the mail information is stored in the RAM 111 or the storage section 115 (step S75), and processing proceeds to step S76. If no mail is being created, processing proceeds to step S76.

In step S76, the control section 101 redisplays the music player screen associated with execution of the music function (step S76; for instance, a screen display of FIG. 17A). In step S63 or a subsequent step, a music function is executed as is, and the display shifts as described above. However, a sound output of the music generated by the speaker 109 is continued.

[Photostand Function]

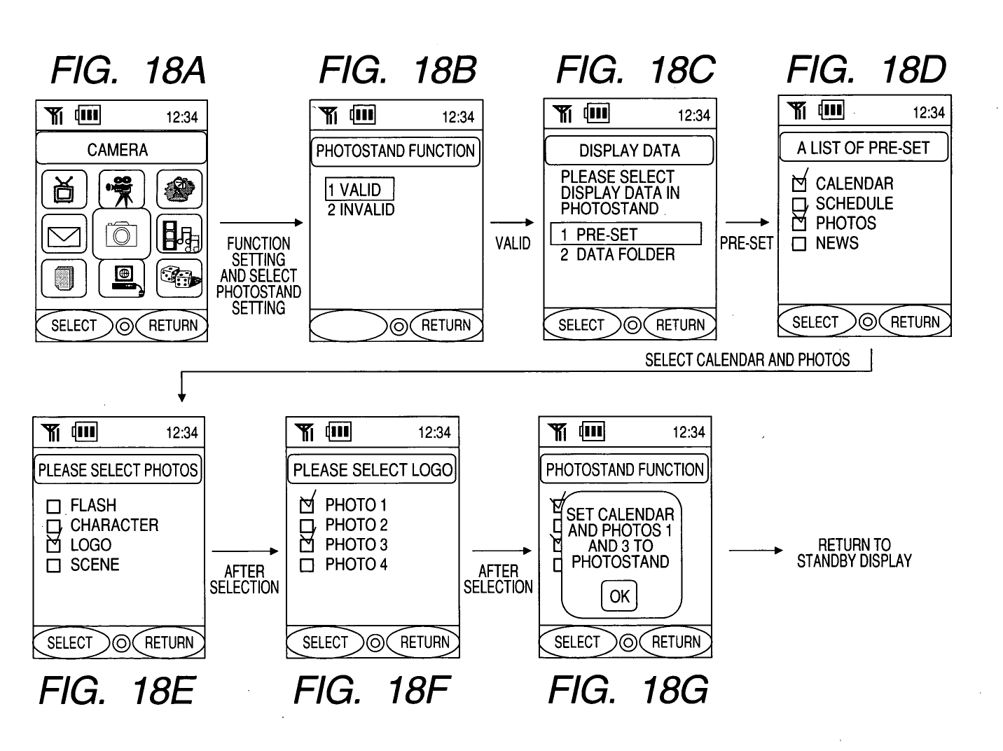

Next, a Photostand function of the portable cellular phone 1 of embodiment is described by reference to FIGS. 18A through 20C. FIGS. 18A-18D are views for describing a method for setting the photostand function. Here, the term “photostand function” means a function for indicating various displays on the display 5 if the portable cellular phone 1 is recharged with an electric current upon connection with the recharging unit 20 or the recharging cord 21 in FIG. 5.

First, if the ENTER key 65 is depressed with the standby screen displayed, the first function list screen is displayed (details of the operation have already been described by reference to FIGS. 8A-8E, or the like, and hence are omitted here for brevity) as shown in FIG. 18A. Subsequently, predetermined operation, such as a “function setting,” “photostand setting,” or the like, is performed with the first function list screen, and a screen used for determining whether to render the photostand function active or inactive is displayed as shown in FIG. 18B. If “active” is selected by the ENTER key 65 in FIG. 18B, a screen used for selecting data displayed during the photostand function is displayed as shown in FIGS. 18C, 18D, 18E, and 18F.

As shown in FIG. 18D, a list for selecting data to be displayed is displayed, and options; e.g., a calendar, a schedule, a photo, news, and the like, are displayed, so that the user can select data to be displayed. A plurality of data items can be selected from among the options.

As shown in FIG. 18G, if the data to be displayed are determined, data to be displayed during the photostand function can be ascertained. Subsequently, control is performed so as to display the standby screen.

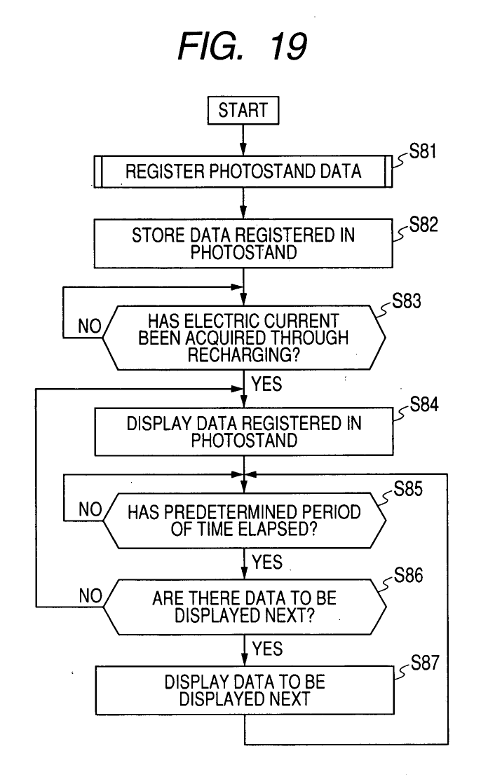

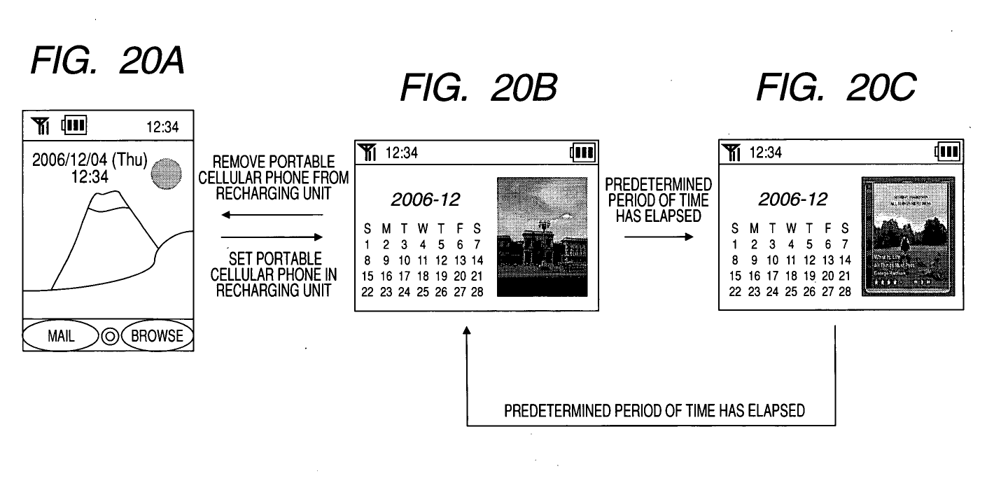

FIG. 19 is a flowchart for describing the photostand function of the portable cellular phone 1. The photostand function is described by use of, as required, a screen transition view of FIGS. 20A-20C along with the flowchart of FIG. 19.

In FIG. 19, data to be displayed during the photostand function are registered as shown in FIGS. 18A-18G in the manner mentioned previously (step S81). If having completed registration of the data for the photostand function, the control section 101 stores the registered data into the storage section 115 or the RAM 111 (step S82).

Next, the control section 101 determines whether or not the portable cellular phone 1 has been connected to the recharging unit 20 or the recharging cord 21 and recharged with an electric current (step S83). If the portable cellular phone 1 is determined not to have been supplied with an electric current by recharging operation, processing pertaining to step S83 is reperformed. If determining that the portable cellular phone is supplied with an electric current through recharging operation, the control section 101 displays the data stored in step S82 in landscape orientation (step S84). For instance, if a calendar and photos 1 and 3 (a plurality of photos) are set as shown in FIG. 20B, a calendar and a photo 1 are displayed in step S84.

The control section 101 determines whether or not a predetermined period of time has elapsed since commencement of a display in step S84 (step S85). If the predetermined time has not elapsed, processing pertaining to step S85 is reperformed. If determining in step S85 that the predetermined period of time has elapsed, the control section 101 determines, in step S86, whether or not data to be displayed next are present (step S86). In relation to the determination in step S86 as to whether or not data to be displayed next are present, provided that, e.g., three photos are registered and a calendar is registered and that settings are made such that a calendar and one photo are displayed at one time, the remaining two photos are not yet displayed, and hence data to be displayed next are determined to be present. For instance, if three photos are registered and the calendar is registered and if settings are made such that the calendar and three photos are displayed at one time, display of all of the photos has already been completed, and hence data to be displayed next are determined not to be present.

If data to be displayed next are determined not to be present in step S86, processing pertaining to step S84 is reperformed. If determining in step S86 that data to be displayed next are present, the control section 101 displays the remaining data (step S87). For instance, the display acquired in step S67 is as shown in FIG. 20C, and display of the calendar is continued without modification. The photo 3 that is not displayed in FIG. 20B is displayed concurrently with the calendar. After displaying operation pertaining to step S87 has been commenced, processing proceeds to step S85.

Although unillustrated, the control section 101 determines, in steps S84 through S87, whether or not an electric current is supplied concurrently with processing pertaining to steps S84 through S87. If the electric current is determined not to be supplied, processing pertaining to steps S84 through S87 is completed, and the screen is changed to the standby screen.

According to the embodiment, a function can be easily called and used even if the portable terminal is used in landscape orientation.

What is claimed is:

1. A portable terminal comprising:
a plurality of keys including a first key and a second key;
a display section; and
a display control unit configured to display a list of a first function menu in portrait orientation if the first key is depressed while a standby screen is displayed in the display section, and the display control unit configured to display a list of second function menu capable of being activated in landscape orientation if the second key is depressed while a standby screen is displayed in the display section.

2. The portable terminal according to claim 1, wherein, if one of the second function menu is selected from the list of second function menu after display of the second function menu, the display control unit executes and displays a function corresponding to the one of the second function menu in landscape orientation.

3. The portable terminal according claim 1, wherein, if one of the first function menu is selected from the list of first function menu after display of the first function menu, the display control unit executes and displays a function corresponding to the one of the first function menu in portrait orientation.

4. The portable terminal according to claim 1, wherein one of the first function menu is selected from the first function menu after display of the second function menu, the display control unit executes and displays a function corresponding to the one of the first function menu in portrait orientation.

5. The portable terminal according to claim 1, wherein the plurality of keys further includes a third key, and
wherein if the third key is depressed if one of the second function menu displayed in landscape orientation is activated, the one of the second function menu is displayed in portrait orientation.

6. The portable terminal according to claim 1, wherein if the display control unit determines that the portable terminal changes a closed state into a open state when one of the second function menu is displayed in landscape orientation, the display control unit displays the one of the second function menu in portrait orientation.

7. A portable terminal comprising:
a plurality of keys including a first key and a second key;
a display section; and
a display control unit configured to display a list of a first function menu in portrait orientation if the first key is depressed while a standby screen is displayed in the display section, and the display control unit configured to display a list of a second function menu capable of being activated in landscape orientation if the second key is depressed while a standby screen is displayed in the display section,
wherein, if one of the first function menu is selected after display of the first function menu, the display control unit executes and displays a function corresponding to the one of the first function menu in portrait orientation, and
wherein, if one of the second function menu is selected after display of the second function menu, the display control unit executes and displays a function corresponding to the one of the second function menu in landscape orientation.

8. A portable terminal comprising:
a display section;
a storage section configured to store an image data;
a detection section configured to detect an electric current from the outside; and
a control section configured to cause the display section to display the image data stored in the storage section if the detection section detects the electric current detected by the detection section.

9. The portable terminal according to claim 8, wherein a first image data different from the image data stored in the storage section is displayed at the display section if the electric current from the outside is not detected by the detection section.

10. The portable terminal according to claim 8, wherein an first image data different form the image data stored in the storage section is displayed at the display section before the detection of the electric current from the outside, and wherein the image data stored in the storage section is displayed at the display section after the detection of the electric current from the outside.

11. A portable terminal comprising:
a display section configured to simultaneously display at least two functions;
an operation section including a plurality of keys;
a control section configured to accept an operation corresponding to one of the at least two functions if the operation is performed by a first key of the plurality of keys; and
a switch control section capable of switching to a display relevant to the other of the at least two functions if operation is performed by the second key of the plurality of keys.

12. The portable terminal according to claim 11, wherein if the first function and the second function are selected by at least one of the plurality of keys, the first function and the second function are simultaneously displayed by the display section.

13. The portable terminal according to claim 11, wherein, if the first function is selected from the at least one function by at least one of the plurality of keys while the first function and the second function have been simultaneously displayed by the display section, the first function is entirely displayed at the display section.

14. The portable terminal according to claim 11, wherein the first function is entirely displayed at the display section and the section function is not displayed at the display section, and
wherein, if one of the at least one function other than the first function and the second function is selected by at least one of the plurality of keys, the first function and the the selected one of the at least one function are simultaneously displayed at the display section.
